(19) United States
(12) Patent Application Publication
(10) Pub. No.: US 2012/0269570 A1
(43) Pub. Date: Oct. 25, 2012

(54) FLOTATION DEVICE CONNECTING KIT AND METHOD OF THEREFOR

(76) Inventor: Anthony Alan Felber, Tempe, AZ (US)

(21) Appl. No.: 13/274,681

(22) Filed: Oct. 17, 2011

Related U.S. Application Data
(60) Provisional application No. 61/394,694, filed on Oct. 19, 2010.

(51) Int. Cl. B63B 35/85; F16B 17/00

(52) U.S. Cl. 403/205; 403/345

(57) ABSTRACT

A connector system for flotation devices has a plurality of connectors. Each connector allows at least one flotation device to attach together and to attach a plurality of other flotation devices together.

### RELATED APPLICATIONS

This invention claims priority, under 35 U.S.C. §120, to the U.S. Provisional Patent Application No. 61/394,694 filed on Oct. 19, 2010, in the name of the same inventor and which application is incorporated by reference herein.

### BACKGROUND

This invention relates generally to flotation devices, and more specifically, to a flotation device connector/system which may allow one to connect a plurality of flotation devices together.

Pool noodles are a popular type of flotation device that may be used in swimming pools and other types of swimming areas. Pool noodles may be formed of an elongated piece of flexible Styrofoam and/or other closed cell foam material. Typical pool noodles may be five to six feet in length having a diameter of approximately three to six inches. A channel may run through a length of the pool noodle. In general, the only way to use pool noodles is for individuals to sit and or lay on one or more pool noodles. Currently, there is no device and or system to attach multiple pool noodles together.

Therefore, it would be desirable to provide a device and method that overcomes the above problems.

### SUMMARY

A connector system for flotation devices has a plurality of connectors. Each connector allows at least one flotation device to attach together and to attach a plurality of other flotation devices together.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of the connectors according to one embodiment the present invention;

FIG. 2 is an elevated perspective view of the “L” shaped connector of the present invention;

FIG. 3 is an elevated perspective view of the linking connector of the present invention;

FIG. 4 is an elevated perspective view of the end connector of the present invention;

FIG. 5 is an elevated perspective view of a sword handle of the present invention;

FIG. 6 is an elevated perspective view of a multi-connector of the present invention;

FIG. 7 is an elevated perspective view of a pool noodle knife of the present invention; and

FIG. 8 is an elevated perspective view of an example of the connector system of the present invention in use. Common reference numerals are used throughout the drawings and detailed description to indicate like elements.

### DETAILED DESCRIPTION

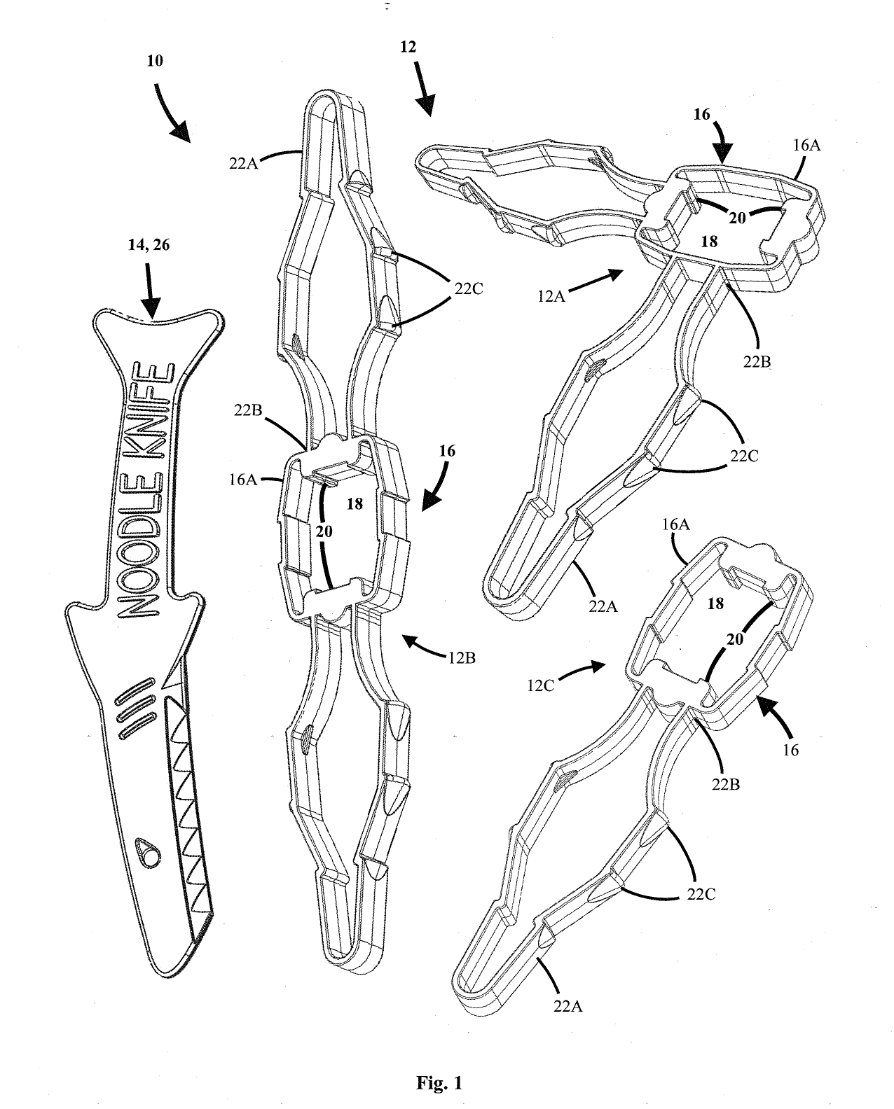

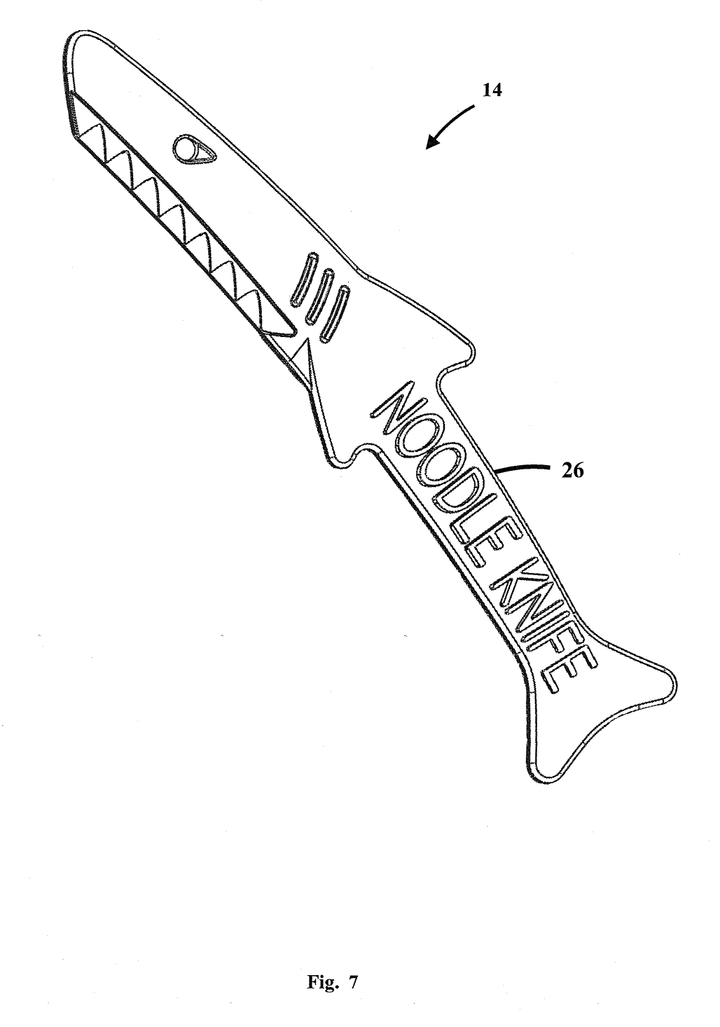

Referring to the FIG. 1, an elevated perspective view of the connector system 10 is shown. The connector system 10 may be formed of one or more connectors 12. The plurality of connectors 12 may be used to attached one or more pool noodle floatation device (hereinafter pool noodle 28 (FIG. 7)) together to form different shapes and or objects. The connector system 10 may further have a cutting device 14. The cutting device may be used to cut the pool noodles to a desired size.

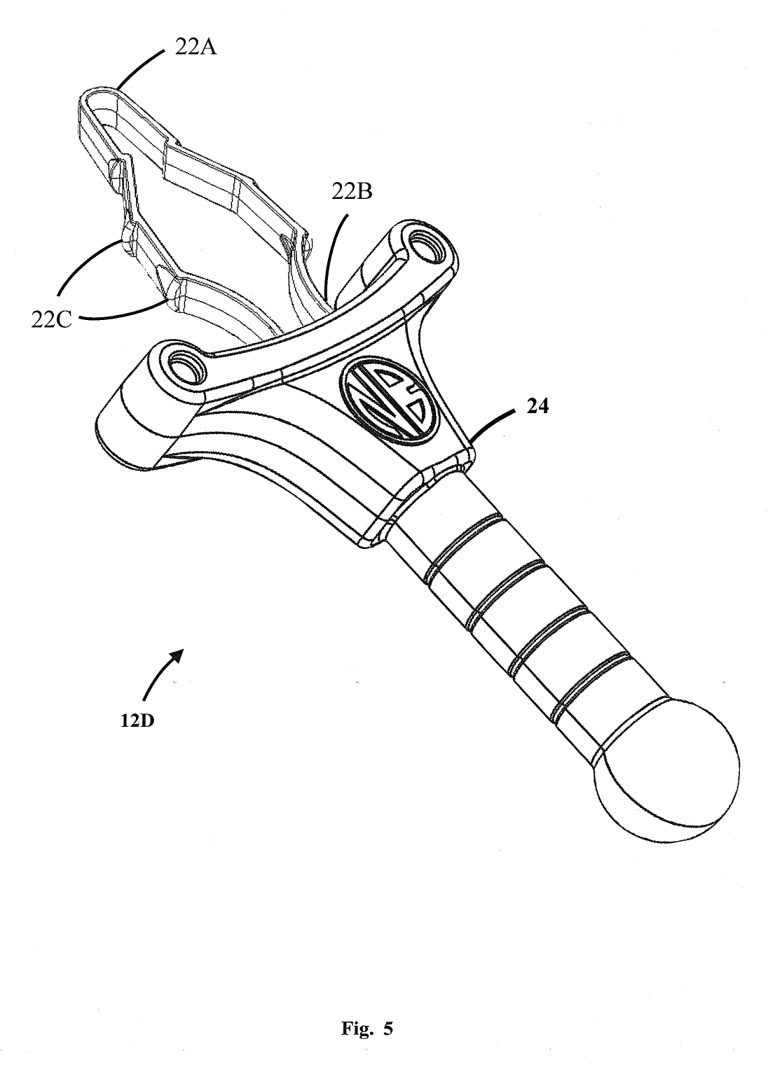

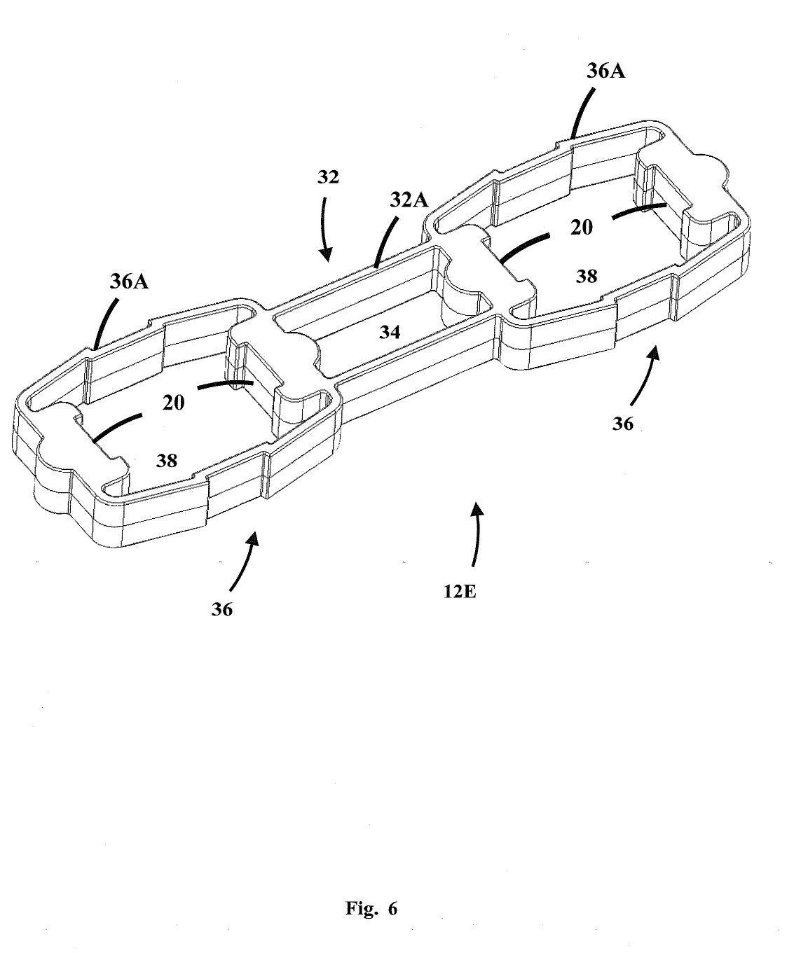

As shown in FIG. 1, the connectors 12 may come in one or more different shapes. The connectors 12 may be formed as an “L” shaped connector 12A, a linking connector 12B, an end connector 12C, a sword connector 12D (FIG. 5), a multi-connector 12E (FIG. 6), and the like. The connectors 12 may be formed of a lightweight but sturdy material such as plastic or the like.

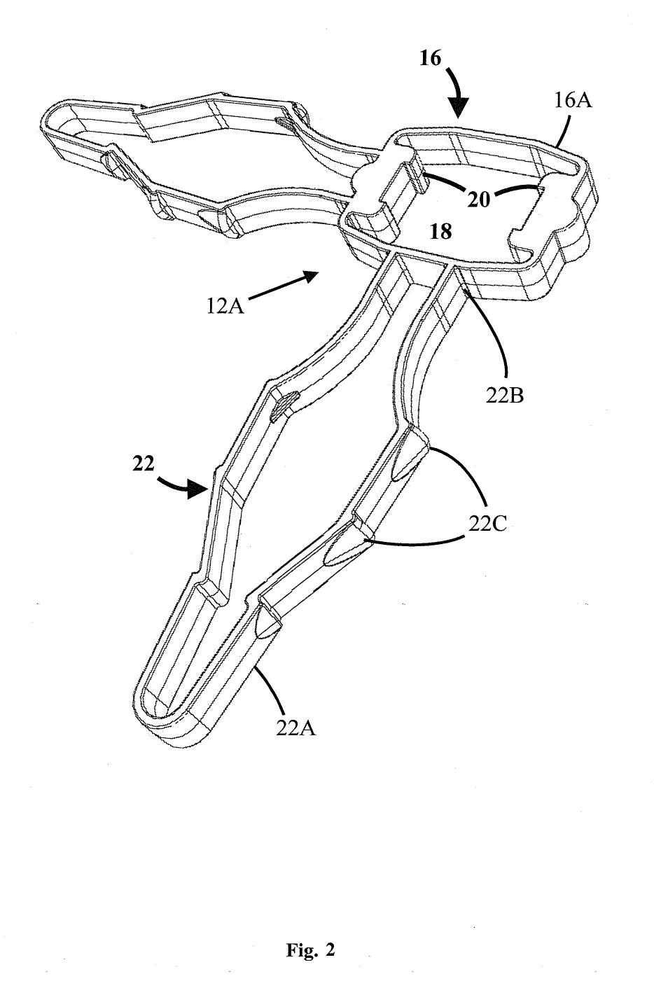

Referring now to FIGS. 1 and 2, an “L” shaped connector 12A may be described. The “L” shaped connector 12A may have a central section 16. The central section 16 may be a ring type member 16A having a central opening 18. The ring type member 16A may come in different geometrical shapes. As shown in the figures, the ring type member 16A is rectangular in shape. However, this is shown as an example and should not be seen in a limiting manner. The central opening 18 may have one or more protrusions 20 formed on an interior perimeter thereof. In the embodiment shown, a pair of protrusions 20 is formed on opposite sides of the central opening 18. The protrusions 20 may be used to secure another connector 12 within the central opening 18 or alternatively, a pool noodle within the central opening 18. The central opening 18 may be sized to be smaller than a diameter of the pool noodle. By slightly compressing an end of the pool noodle, one may insert the pool noodle through the central opening 18. The pool noodle will then expand in the central opening 18 thereby securing the pool noodle in the central opening 18. The protrusions 20 may provide further resistance to secure a pool noodle with in the central opening 18.

One or more leg members 22 may extend away from the central section 16. For the “L” shape connector 12A, a pair of leg members 22 may be used. The pair of leg members 22 may extend from the central section 16 at an approximately 90° angle to form the “L” shape. Each leg member 22 may be oblong in shape. Each leg member 22 may be formed of a single bar member 22A bent in an oblong shape where both end members 22B of the bar member 22A may be attached to the central section 16. The bar member 22A may have one or more protrusions 220 extending from an exterior surface thereof. The protrusions 22C may be formed in a shape of barbs. In operation, the leg member 22 may be squeezed together and inserted into the channel formed through the pool noodle. Once inserted into the channel, the leg member 22 may expand in the channel. The protrusions 22C aid in keeping the leg member 22 in the channel.

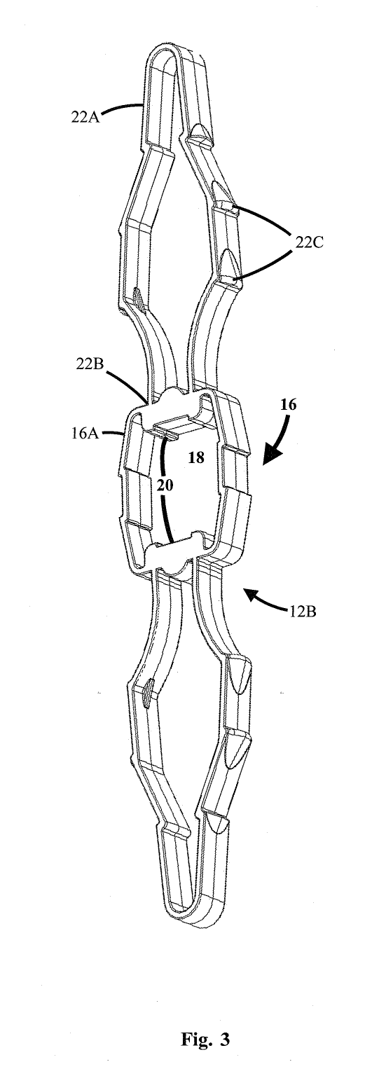

Referring now to FIGS. 1 and 3, a linking connector 12B may be discussed. Similar to the “L” shaped connector 12A previously disclosed, linking connector 12B may have a central section 16. The central section 16 may be a ring type member 16A having a central opening 18. The ring type member 16A may come in different geometrical shapes. As shown in the figures, the ring type member 16A is rectangular in shape. However, this is shown as an example and should not be seen in a limiting manner. The central opening 18 may have one or more protrusions 20 formed on an interior perimeter thereof. In the embodiment shown, a pair of protrusions 20 is formed on opposite sides of the central opening 18. The protrusions 20 may be used to secure another connector 12 within the central opening 18 or a pool noodle within the central opening 18. The central opening may be sized to be smaller than a diameter of the pool noodle. By slightly compressing an end of the pool noodle, one may insert the pool noodle through the central opening 18. The pool noodle will then expand in the central opening 18 thereby securing the pool noodle in the central opening 18. The protrusions 20 may provide further resistance to secure a pool noodle with in the central opening 18.

One or more leg members 22 may extend away from the central section 16. For the linking connector 12B, a pair of leg members 22 may be used. The pair of leg members 22 may extend from the central section 16 in opposite directions. Each leg member 22 may be oblong in shape. Each leg member 22 may be formed of a single bar member 22A bent in an oblong shape where both end members 22B of the bar member 22A may be attached to the central section 16. The bar member 22A may have one or more protrusions 22C extending from an exterior surface thereof. The protrusions 22C may be formed in a shape of barbs. In operation, the leg member 22 may be squeezed together and inserted into the channel formed through the pool noodle. Once inserted into the channel, the leg member 22 may expand in the channel. The protrusions 22C aid in keeping the leg member 22 in the channel.

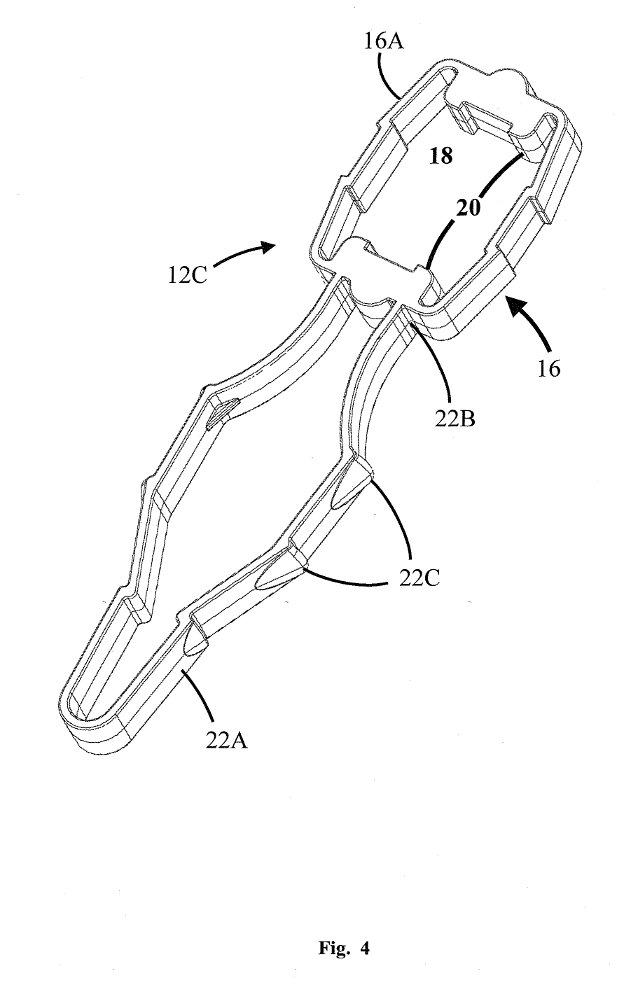

Referring now to FIGS. 1 and 4, an end connector 12C may be disclosed. The end connector 12C is similar to the other connectors previously disclosed. The end connector 12C may have a central section 16. The central section 16 may be a ring type member 16A having a central opening 18. The ring type member 16A may come in different geometrical shapes. As shown in the figures, the ring type member 16A is rectangular in shape. However, this is shown as an example and should not be seen in a limiting manner. The central opening 18 may have one or more protrusions 20 formed on an interior perimeter thereof. In the embodiment shown, a pair of protrusions 20 is formed on opposite sides of the central opening 18. The protrusions 20 may be used to secure a pool noodle with in the central opening 18. The central opening 18 may be sized to be smaller than a diameter of the pool noodle. By slightly compressing an end of the pool noodle, one may insert the pool noodle through the central opening 18. The pool noodle will then expand in the central opening 18 thereby securing the pool noodle in the central opening 18. The protrusions 20 may provide further resistance to secure another connector 12 within the central opening 18 or a pool noodle within the central opening 18.

One or more leg members 22 may extend away from the central section 16. For the end connector 12C, a single leg member 22 may be used. The leg member 22 may extend away from the central section 16. The leg member 22 may be oblong in shape. The leg member 22 may be formed of a single bar member 22A bent in an oblong shape where both end members 22B of the bar member 22A may be attached to the central section 16. The bar member 22A may have one or more protrusions 22C extending from an exterior surface thereof. The protrusions 22C may be formed in a shape of barbs. In operation, the leg member 22 may be squeezed together and inserted into the channel formed through the pool noodle. Once inserted into the channel, the leg member 22 may expand in the channel. The protrusions 22C aid in keeping the leg member 22 in the channel.

Referring now to FIGS. 1 and 5, a sword handle connector 12D may be disclosed. The sword handle connector 12D has a handle section 24. The handle section 24 may be shaped similarly to a hilt of the sword.

One or more leg members 22 may extend away from the central section 16. For the sword handle connector 12D, a single leg member 22 may be used. The leg member 22 may extend away from the handle section 24. The leg member 22 may be oblong in shape. The leg member 22 may be formed of a single bar member 22A bent in an oblong shape where both end members 22B of the bar member 22A may be attached to the handle section 24. The bar member 22A may have one or more protrusions 22C extending from an exterior surface thereof. The protrusions 22C may be formed in a shape of barbs. In operation, the leg member 22 may be squeezed together and inserted into the channel formed through the pool noodle. Once inserted into the channel, the leg member 22 may expand in the channel. The protrusions 22C aid in keeping the leg member 22 in the channel.

Referring now to FIG. 6, a multi-connector 12E may be disclosed. The multi-connector 12E may have a center member 32. The center member 32 may be a ring member 32A having a central opening 34. The ring member 32A may come in different geometrical shapes. As shown in the figures, the ring member 32A is rectangular in shape. However, this is shown as an example and should not be seen in a limiting manner. The central opening 34 may have one or more protrusions 20 formed on an interior perimeter thereof. In the embodiment shown, a pair of protrusions 20 is formed on opposite sides of the central opening 34.

One or more connecting members 36 may extend away from the central member 32. In the present embodiment, a pair of connecting members 36 may extend away in opposite directing from the central member 32. The connecting members 36 may be used to attach other connectors 12 to the multi-connector 12E. Each connecting member 36 may be a ring member 36A having a central opening 38. The ring member 36A may come in different geometrical shapes. As shown in the figures, the ring member 36A is rectangular in shape. However, this is shown as an example and should not be seen in a limiting manner. The central opening 38 may have one or more protrusions 20 formed on an interior perimeter thereof. In the embodiment shown, a pair of protrusions 20 is formed on opposite sides of the central opening 38. The protrusions 20 may be used to secure a pool noodle with in the central opening 38. The central opening 38 may be sized to be smaller than a diameter of the pool noodle. By slightly compressing an end of the pool noodle, one may insert the pool noodle through the central opening 38. The pool noodle will then expand in the central opening 38 thereby securing the pool noodle in the central opening 38. The protrusions 20 may provide further resistance to secure another connector 12 within the central opening 38.

Referring to FIGS. 1 and 7, a cutting device 14 is shown. The cutting device 14 may be similar to a box cutter or the like. The cutting device 14 shown may have a handle section shaped in an aquatic theme. In the embodiment shown in FIGS. 1 and 6, the handle section 26 is shaped like a shark. However, this is shown as an example and should not be seen in a limiting manner. The cutting device may be used to cut the pool noodles to a desired size.

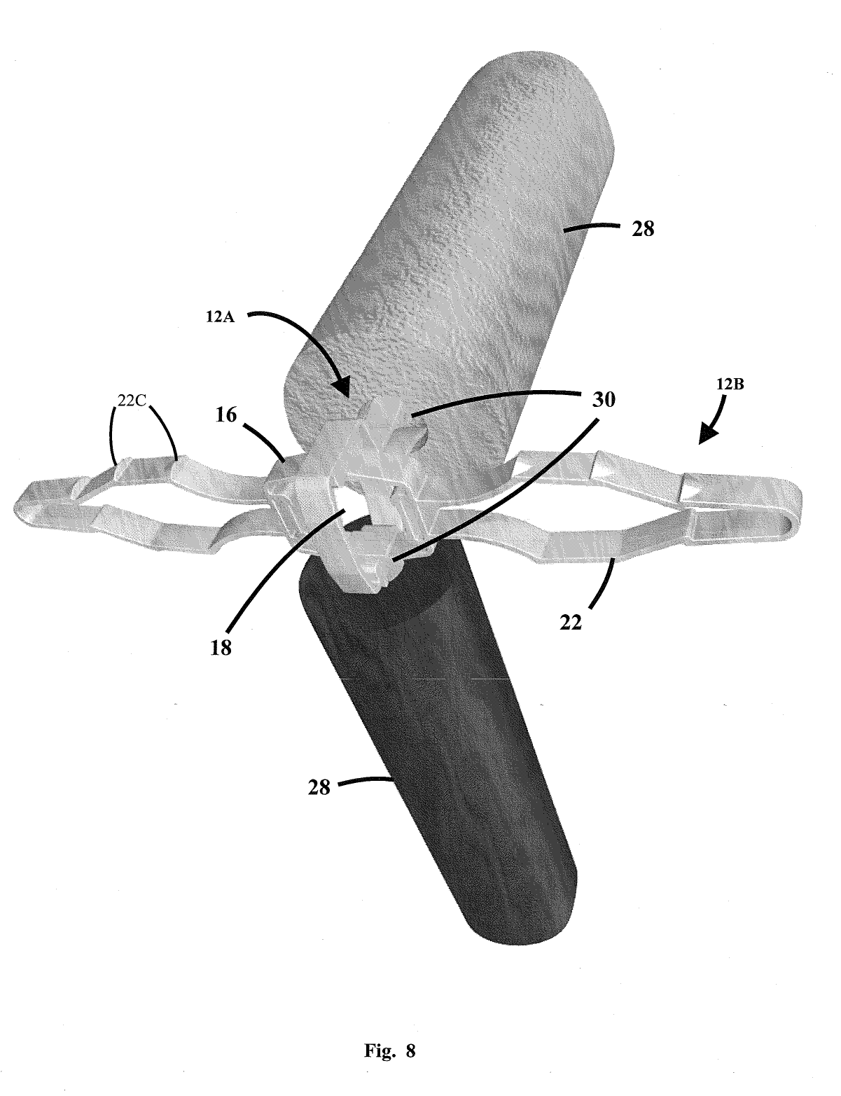

Referring to FIG. 8, one example of the how the connector system 10 may be used is shown. As may be seen, the pool noodles 28 have a channel 30 which runs through a length of the pool noodle 28 in a central area thereof. In the present embodiment, the leg member 22 of an “L” shaped connector 12A may be squeezed together and inserted into the channel 30 formed through the pool noodles 28. Once inserted into the channel 30, the leg member 22 may expand in the channel 30. The protrusions 22C aid in keeping the leg member 22 in the channel 30. Another connector 12 may be inserted in the central opening 18 of the “L” shaped connector 12A. In the present embodiment, a link connector 128 is positioned in the central opening 18 of the “L” shaped connector 12A such that the central section 16 of the link connector 12B is positioned within the central section 16 of the “L” shaped connector 12A. The exterior surface of the central section 16 of the link connector 12B presses against the interior surface of the central opening 18 of the “L” shaped connector 12A securing the two connectors 12 together. The protrusions 20 may provide further resistance to the two connectors 12 together.

While embodiments of the disclosure have been described in terms of various specific embodiments, those skilled in the art will recognize that the embodiments of the disclosure can be practiced with modifications within the spirit and scope of the claims.

What is claimed is:

1. A connector system for flotation devices comprising:
a plurality of connectors, wherein each connector allows at least one flotation device to attach together and to attach a plurality of flotation devices together.

2. The connector system of claim 1, wherein the plurality of connectors comprises at least one “L” shaped connector.

3. The connector system of claim 1, wherein the plurality of connectors comprises at least one linking connector.

4. The connector system of claim 1, wherein the plurality of connectors comprises at least one end connector.

5. The connector system of claim 1, wherein the plurality of connectors comprises at least one sword shaped connector.

6. The connector system of claim 1, wherein each of the plurality of connectors comprises:
a central ring section having an opening formed there through; and
at least one leg member extending from the central ring section.

7. The connector system of claim 6, wherein each of the plurality of connectors further comprises: protrusions extending from an interior section of the opening.

8. The connector system of claim 6, wherein the at least one leg member comprises: a bar member having a first and second ends attached to the central ring, the bar formed in an oblong shape.

9. The connector system of claim 8, wherein the at least one leg member further comprises tab members extending from an exterior surface of the bar member to form barbs.

10. The connector system of claim 1, wherein the plurality of connectors comprises:
an “L” shape connector; and
a linking connector.

11. The connector system of claim 10, wherein the plurality of connectors further comprises an end connector.

12. The connector system of claim 10, wherein the plurality of connectors further comprises a sword handle connector.

13. The connector system of claim 10, wherein the “L” shape connector comprises:
a central ring section having an opening formed there through; and
a pair of leg member extending from the central ring section at an approximately 90° angle, wherein each leg member comprises:
a bar member having a first and second ends attached to the central ring, the bar formed in an oblong shape.

14. The connector system of claim 10, wherein the linking connector comprises:
a central ring section having an opening formed there through; and
a pair of leg member extending from the central ring section in opposite directions, wherein each leg member comprises:
a bar member having a first and second ends attached to the central ring, the bar formed in an oblong shape.

15. The connector system of claim 11, wherein the end connector comprises:
a central ring section having an opening formed there through; and
a leg member extending from the central ring section, wherein the leg member comprises:
a bar member having a first and second ends attached to the central ring, the bar formed in an oblong shape.

16. The connector system of claim 12, wherein the sword handle connector comprises:
a handle section configured as a hilt; and
a leg member extending from the central ring section, wherein the leg member comprises:
a bar member having a first and second ends attached to the central ring, the bar formed in an oblong shape.

17. A connector system for flotation devices comprising:
a plurality of connectors, wherein each connector allows at least one flotation device to attach together and to attach a plurality of flotation devices together, wherein the plurality of connectors comprises:
an “L” shape connector;
a linking connector; and
an end connector;
wherein each of the plurality of connectors comprises:
a central ring section having an opening formed there through;
protrusions extending from an interior section of the opening; and
at least one leg member extending from the central ring section, wherein the at least one leg member comprises:
a bar member having a first and second ends attached to the central ring, the bar formed in an oblong shape; and
tab members extending from an exterior surface of the bar member to form barbs.

18. The connector system of claim 17, wherein the plurality of connectors further comprises a sword handle connector.

19. The connector system of claim 18, wherein the sword handle connector comprises:
a handle section configured as a hilt; and
a sword handle leg member extending from the central ring section, wherein the sword handle leg member comprises:
a sword handle bar member having a first and second ends attached to the central ring, the sword handle bar formed in an oblong shape.

20. The connector system of claim 19, wherein sword handle connector comprises bar tab members extending from an exterior surface of the sword handle bar member to form barbs.

21. The connector system of claim 1, wherein the plurality of connectors comprises at least one multi-connector.

22. The connector system of claim 21, wherein the at least one multi-connector comprises:
a central member; and
a plurality of connecting members extending away from the central member, the connecting member allows one to attach another connector to the at least one multi-connector or a flotation device to the to the at least one multi-connector.
